(19) United States
(12) Patent Application Publication
(10) Pub. No.: US 2024/0310703 A1
(43) Pub. Date: Sep. 19, 2024

(54) PROJECTION DEVICE AND CONTROL METHOD THEREOF

(71) Applicant: Coretronic Corporation, Hsin-Chu (TW)

(72) Inventors: I-Ting Liao, Hsin-Chu (TW); Fan-Chieh Chang, Hsin-Chu (TW); Chen-Yi Hong, Hsin-Chu (TW)

(73) Assignee: Coretronic Corporation, Hsin-Chu (TW)

(21) Appl. No.: 18/599,143

(22) Filed: Mar. 7, 2024

(30) Foreign Application Priority Data
Mar. 13, 2023 (CN) 202310234918.1

(51) Int. Cl. G03B 21/14; G02B 7/00; G03B 5/00

(52) U.S. Cl. CPC G03B 21/145; G02B 7/005; G03B 5/00

(57) ABSTRACT

A projection device and a control method of the projection device are provided. The control method of the projection device includes following steps. Position information of the projection device is obtained by a sensor. A first moving signal is generated by at least one processor according to the position information. According to the first moving signal, a projection lens module is controlled by a driving member to move relative to the projection device.

### CROSS-REFERENCE TO RELATED APPLICATION

This application claims the priority benefit of China application serial no. 202310234918.1, filed on Mar. 13, 2023. The entirety of the above-mentioned patent application is hereby incorporated by reference herein and made a part of this specification.

### BACKGROUND

### Technical Field

The invention relates to a projection technology and particularly relates to a projection device and a control method thereof.

### Description of Related Art

An existing ultra short focal projection device is, in most cases, capable of projecting images of one single size. An user who intends to adjust a size of a projected image is required to move the entire projection device to change a distance between the projection device and a projection target (e.g., a screen or a wall). After the position of the projection device is set, if the projection device accidentally collides with something and is shifted, the user needs to move the entire projection device again to adjust the projected image. In another aspect, if the user intends to watch the projected image of a large size, the user is required to place the projection device at a position far away from the projection target. As such, a lot of available space may be wasted.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a projection device and a control method of the projection device capable of controlling a projection lens module to move relative to the projection device, so as to adjust a size of a projected image.

Other objectives and advantages of the invention may further be learned from technical features disclosed in the invention.

In order to achieve one or a portion of or all of the objects or other objects, an embodiment of the invention provides a projection device that includes an optical engine module, a projection lens module, a sensor, a driving member, and at least one processor. The optical engine module is configured to provide an image beam. The projection lens module is disposed on a transmission path of the image beam and configured to project the image beam out of the projection device. The sensor is configured to obtain position information of the projection device. The driving member is coupled to the projection lens module. The at least one processor is coupled to the sensor and the driving member. The at least one processor generates a first moving signal according to the position information and transmits the first moving signal to the driving member, and the driving member controls the projection lens module to move relative to the projection device according to the first moving signal.

In order to achieve one or part or all of the above objects or other objects, an embodiment of the invention provides a control method of a projection device, where the projection device includes a sensor, a driving member, at least one processor, and a projection lens module configured to project an image beam, and the control method includes following steps. Position information of the projection device is obtained by the sensor. A first moving signal is generated by the at least one processor according to the position information. According to the first moving signal, the projection lens module is controlled by the driving member to move relative to the projection device.

In view of the above, the projection device provided in one or more embodiments of the invention may control the projection lens module through the driving member to move relative to the projection device, so as to enlarge or reduce a projected image within the proper range of the projection size.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a projection device according to an embodiment of the invention.

FIG. 2 is a schematic view illustrating a projection lens module moves relative to the projection device according to an embodiment of the invention.

FIG. 3A and FIG. 3B are flowcharts illustrating a control method of the projection device according to an embodiment of the invention.

FIG. 4 is a flowchart illustrating a control method of the projection device according to another embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

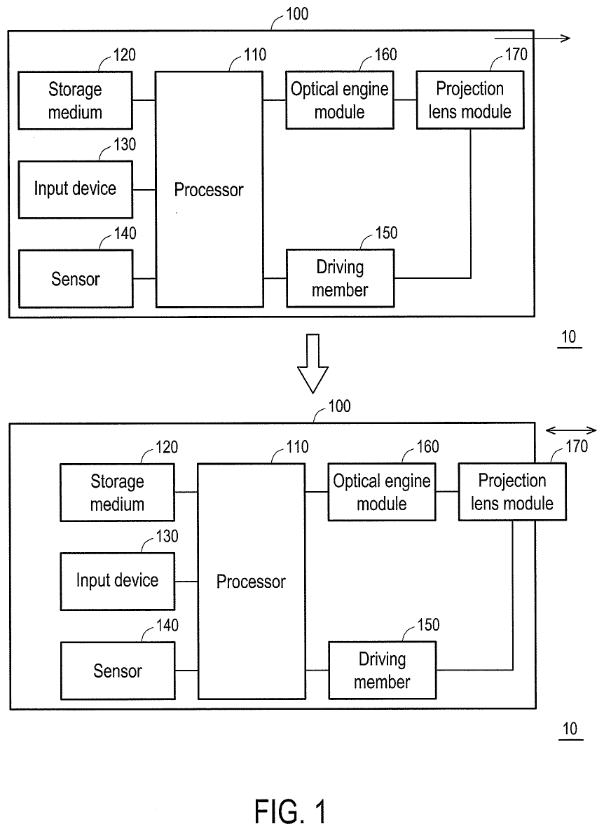

FIG. 1 is a schematic view illustrating a projection device 10 according to an embodiment of the invention. The projection device 10 may include a housing 100, at least one processor 110 (FIG. 1 illustrates one processor as an example), a storage medium 120, an input device 130, a sensor 140, a driving member 150, an optical engine module 160, and a projection lens module 170. The at least one processor 110, the storage medium 120, the input device 130, the sensor 140, the driving member 150, and the optical engine module 160 may be disposed in the housing 100. The projection lens module 170 may be embedded in the housing 100. The housing 100 of the projection device 10 may be fixed at a specific location (e.g., on a table or a ceiling).

The at least one processor 110 is, for instance, a central processing unit (CPU), any other programmable general purpose or special purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), another similar element, or a combination of the above-mentioned elements. The number of the at least one processor 110 may be one or multiple. The at least one processor 110 is coupled (electrically connected) to the storage medium 120, the input device 130, the sensor 140, the driving member 150, the optical engine module 160, and the projection lens module 170, and the at least one processor 110 may access and execute a number of modules and various application programs stored in the storage medium 120.

The storage medium 120 is, for instance, any type of fixed or movable random access memory (RAM), read only memory (ROM), flash memory, hard disk drive (HDD), solid state drive (SSD), or any other similar element, or a combination of the above-mentioned elements. The storage medium 120 is configured to store the modules or the application programs which may be executed by the at least one processor 110.

The input device 130 is configured to receive a user command. The user may operate the projection device 10 through the input device 130. The input device 130 may include keys, a button, a touch screen, or the like, for instance.

The sensor 140 is configured to measure position information of the projection device 10, where the position information is, for instance, a distance between the projection device 10 and a projection target (e.g., a screen or a wall). The sensor 140 may be, for instance, a time of flight (ToF) sensor.

The driving member 150 is coupled (electrically connected) to the projection lens module 170 and may be configured to control the projection lens module 170 to move relative to the projection device 10 (the housing 100). When the at least one processor 110 intends to control the projection lens module 170 to move, the at least one processor 110 may transmit a moving signal to the driving member 150. The driving member 150 may control the projection lens module 170 to move relative to the projection device 10 (the housing 100) according to the moving signal, where a moving distance of the projection lens module 170 is associated with the moving signal.

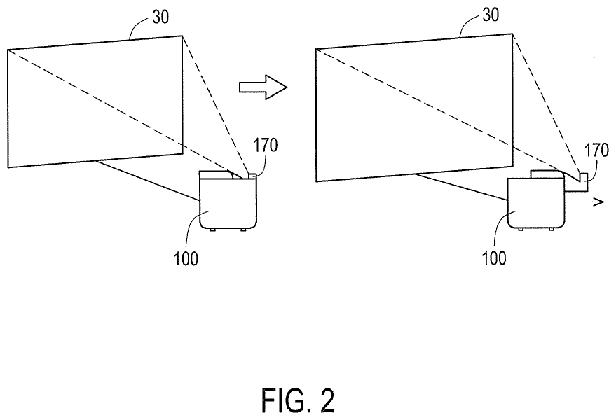

The driving member 150 includes, for instance, at least one of a motor, a belt, a rack, a screw, a steel wire and a gear. When the projection lens module 170 is controlled by the driving member 150 to move relative to the projection device 10 on a sliding rail, the projection lens module 170 may protrude from the housing 100, as shown in FIG. 1. FIG. 2 is a schematic view illustrating the projection lens module 170 moves relative to the projection device 10 (the housing 100) according to an embodiment of the invention. When the projection lens module 170 moves relative to the projection device 10 and protrudes from the housing 100, a projection size of an image 30 projected by the projection lens module 170 on the projection target (e.g., a screen or a wall) may be changed. For instance, the projection lens module 170 is a reflective ultra short focal projection lens, as shown on the right side of FIG. 2; the longer the moving distance of the projection lens module 170, i.e., the longer the length of the projection lens module 170 protruding from the housing 100 is, the larger the projection size of the image 30 is. As shown on the left side of FIG. 2, the shorter the moving distance of the projection lens module 170, e.g., the shorter the length of the projection lens module 170 protruding from the housing 100 is, the smaller the projection size of the image 30 is. That is, the projection device 10 provided in this embodiment may be placed at a fixed position and may project the image 30 of different projection sizes.

With reference to FIG. 1, the optical engine module 160 is configured to provide an image beam. The optical engine module 160 may include a light source and a light valve. The light source is configured to provide an illumination beam. The light source may, for instance, include a light emitting diode (LED), a laser diode (LD), or a combination thereof. The light source may also be used together with a wavelength conversion element (phosphor wheel), a light homogenizing element (rod), a light filtering element (filter wheel), at least one light guiding element (mirror, beam splitter), or a combination thereof. The light valve is located on a transmission path of the illumination beam, and the light valve is configured to convert the illumination beam to the image beam. The light valve may include a digital micro-mirror device (DMD), a liquid crystal on silicon (LCOS) panel, a liquid crystal display (LCD), or any other spatial optical modulators.

The projection lens module 170 may be disposed on a transmission path of the image beam provided by the optical engine module 160, and may be configured to project the image beam out of the projection device 10. The projection lens module 170 is, for instance, an ultra short focal lens. The projection lens module 170 may include a combination of one or a plurality of optical lenses having a diopter, such as a biconcave lens, a biconvex lens, a concave-convex lens, a convex-concave lens, a plano-convex lens, a plano-concave lens, any other non-planar lens, or a combination thereof. In an embodiment, the projection lens module 170 may include a planar optical lens and may project the image beam from the optical engine module 160 out of the projection device 10 in a reflective or penetrating manner.

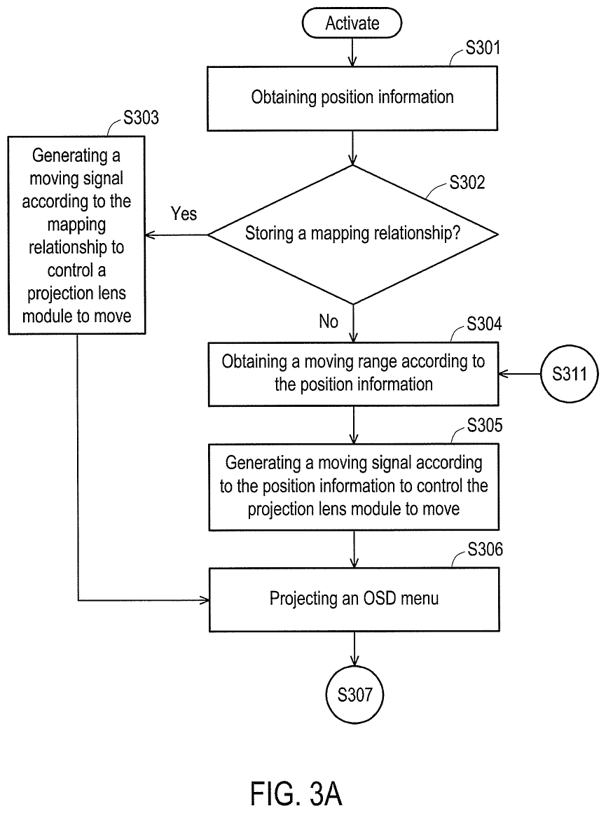

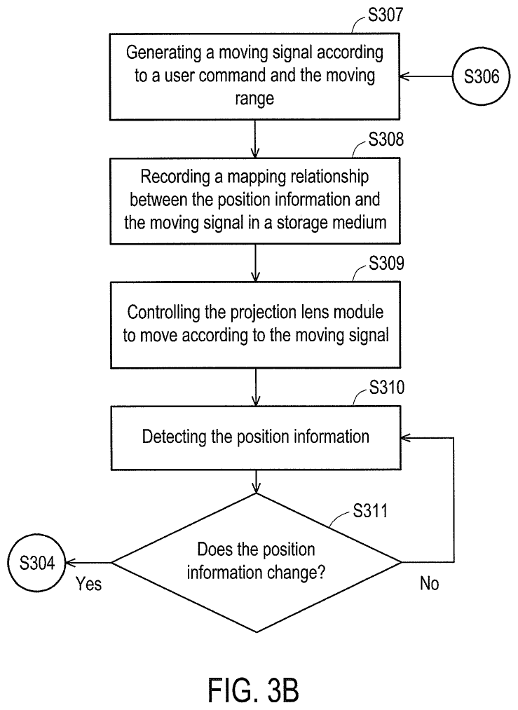

FIG. 3A and FIG. 3B are flowcharts illustrating a control method of the projection device 10 according to an embodiment of the invention. After the projection device 10 is activated, in step S301, the at least one processor 110 may obtain the position information of the projection device 10 through the sensor 140, where the position information is, for instance, the distance between the projection device 10 and the projection target.

In step S302, the at least one processor 110 may determine whether the storage medium 120 stores a mapping relationship between the position information and a specific moving signal. In the embodiment, the mapping relationship may be considered as a use record of the projection device 10. The use record may include the last use record or all historical use records. If there exists a mapping relationship between a position information and a specific moving signal, it indicates that when the projection device 10 was previously used in an environment matching the position information, the at least one processor 110 and the driving member 150 may control the projection lens module 170 to move according to the specific moving signal. Accordingly, the at least one processor 110 may proceed to execute step S303. By contrast, if the mapping relationship between the position information and the specific moving signal does not exist, it indicates that the projection device 10 is used in an environment matching the above position information for the first time, and the at least one processor 110 executes step S304.

In step S303, the at least one processor 110 may generate a moving signal according to the mapping relationship and transmit the moving signal to the driving member 150. The driving member 150 may control the projection lens module 170 according to the moving signal to move relative to the projection device 10, where the moving distance of the projection lens module 170 may be instructed by the moving signal.

For instance, it is assumed that the storage medium 120 has stored a mapping relationship between position information and a specific moving signal, where the position information indicates that when the projection device 10 was used before, the distance between the projection device 10 and the projection target is 50 cm, and the specific moving signal is, for instance, an instruction of controlling the projection lens module 170 to move relative to the projection device 10 by 10 cm. If the position information obtained by the at least one processor 110 in step S301 matches the stored mapping relationship, it indicates that the distance between the current projection device 10 and the projection target is also 50 cm. Accordingly, the at least one processor 110 may generate the specific moving signal to allow the driving member 150 to control the projection lens module 170 to move relative to the projection device 10 by 10 cm. Thereby, the image projected by the projection device 10 may be adjusted to the projection size which the user is accustomed to.

In step S304, the at least one processor 110 may obtain a moving range of the projection lens module 170 according to the position information (e.g., 0 mm to 120 mm). The storage medium 120 may store a lookup table. The lookup table may record the mapping relationships between parameters, such as the position information of the projection device 10, the moving range of the projection lens module 170, and/or a range of the projection size of an image projected by the projection device 10. Table 1 is an example of the lookup table. The at least one processor 110 may obtain the moving range corresponding to the position information by looking up the lookup table according to the position information. For instance, if the position information is 50 cm, the at least one processor 110 may look up the lookup table and obtain the moving range of the projection lens module 170 as 0 mm to 120 mm. When the position information is 40 cm, it means that the projection device 10 is placed at a position closer to the projection target. Accordingly, the maximum projection size of the image projected by the projection device 10 is, for instance, 110 inches. In the embodiment, the projection size of the image projected by the projection device 10 is, for instance, set to be at least 100 inches. Accordingly, when the position information is 40 cm, the minimum value of the moving range of the projection lens module 170 is 100 mm, so that the projection size is at least 100 inches.

TABLE 1

| Position information | Moving range | Range of the projection size |
|---|---|---|
| (cm) | (mm) | (inches) |
| 400 | 100-1200 | 100-1100 |
| 500 | 0-1200 | 100-1300 |
| 600 | 0-200 | 120-1300 |

In step S305, the at least one processor 110 may generate a moving signal according to the position information and transmit the moving signal to the driving member 150. The driving member 150 may control the projection lens module 170 to move relative to the projection device 10 according to the moving signal, where the moving distance of the projection lens module 170 may be instructed by the moving signal. The at least one processor 110 may generate the moving signal according to the moving range. The minimum value of the moving range corresponds to the minimum projection size of the image projected by the projection device 10, and the maximum value of the moving range corresponds to the maximum projection size of the image projected by the projection device 10. The at least one processor 110 may generate the moving signal to control the projection lens module 170 to move within the moving range. In an embodiment, the at least one processor 110 may generate the moving signal according to the minimum value of the moving range, so that the projection device 10 projects an image of the minimum projection size. For instance, when the position information is 40 cm, the moving range of the projection lens module 170 is 100 mm to 120 mm. The at least one processor 110 may generate the moving signal according to the minimum value of the moving range (i.e., 100 mm) and transmit the moving signal to the driving member 150. The driving member 150 may control the projection lens module 170 to move relative to the projection device 10 by 100 mm according to the moving signal, so that the projection device 10 may project an image of the minimum projection size (i.e., 100 inches). When the position information is 50 cm, since the minimum value of the moving range of the projection lens module 170 is 0 mm, the moving signal generated by the at least one processor 110 may be an instruction of not moving the projection lens module 170, and thereby the projection device 10 projects an image of the minimum projection size (i.e., 100 inches).

In step S306, the at least one processor 110 projects an OSD menu having a range of the projection size corresponding to the moving range through the projection lens module 170. For instance, when the position information is 50 cm, the OSD menu may be displayed within the range of the projection size of the image projected by the projection lens module 170 as 100 inches to 130 inches for the user to choose from.

In step S307, the at least one processor 110 receives a user command through the input device 130. The user command refers to the user selecting a specific projection size from the range of the projection size. The at least one processor 110 may generate a moving signal according to the user command and the moving range, where the moving signal is an instruction of controlling the projection lens module 170 to move according to the moving distance within the moving range. For instance, if the position information is 50 cm, the user command refers to selecting 130 inches as the projection size of the projection device 10 from the range of the projection size from 100 inches to 130 inches corresponding to the moving range from 0 mm to 120 mm, and the at least one processor 110 may obtain a moving distance as 120 mm corresponding to the projection lens module 170 of the projection size of 130 inches according to the lookup table. The at least one processor 110 then further generates a moving signal corresponding to the moving distance of 120 mm.

In step S308, the at least one processor 110 may record the mapping relationship between the position information and the aforementioned moving signal in the storage medium 120 as a use record. For instance, the at least one processor 110 may record the mapping relationship between the position information of 50 cm and the moving signal corresponding to the moving distance of 120 mm in the storage medium 120.

In step S309, the at least one processor 110 may transmit the moving signal to the driving member 150. The driving member 150 may control the projection lens module 170 to move relative to the projection device 10 according to the moving signal. For instance, the driving member 150 may control the projection lens module 170 to move relative to the projection device 10 (the housing 100) by 120 mm according to the moving signal.

In step S310, the at least one processor 110 may periodically detect the position information measured by the sensor 140. In step S311, the at least one processor 110 may determine whether the position information has changed. If the at least one processor 110 determines that the position information changes, it means that the projection device 10 has been moved. Accordingly, the at least one processor 110 may execute step S304 again to generate a new moving signal according to the changed position information and enable the driving member 170 to control the projection lens module 170 to move relative to the projection device 10 according to the new moving signal. If the at least one processor 110 determines that the position information has not changed, the at least one processor 110 may execute step S310 again to continuously detect the position information.

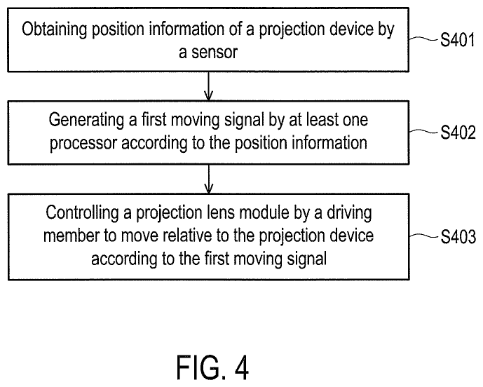

FIG. 4 is a flowchart illustrating a control method of the projection device 10 according to another embodiment of the invention. In step S401, the position information of the projection device is obtained by the sensor. In step S402, the first moving signal is generated by the at least one processor according to the position information. In step S403, the projection lens module is controlled by the driving member to move relative to the projection device according to the first moving signal.

To sum up, the projection device provided in one or more embodiments of the invention may obtain the distance between the projection device and the projection target through the sensor and determine the appropriate range of the projection size for the projected image according to the distance. The projection device may control the projection lens module through the driving member to move relative to the projection device, so as to enlarge or reduce the size of the projected image within the appropriate range of the projection size. Thereby, the projection size may be adjusted in no need of moving the entire projection device, and by extending or retracting the projection lens module, the projection device may be disposed at a position closer to the projection target, so as to prevent the waste of the available space. After the projected image is adjusted, the projection device may store the mapping relationship associated with the measurement results of the sensor and the size of the projected image for future use.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, comprising:
an optical engine module, configured to provide an image beam;
a projection lens module, disposed on a transmission path of the image beam and configured to project the image beam out of the projection device;
a sensor, configured to obtain position information of the projection device;
a driving member, coupled to the projection lens module; and
at least one processor, coupled to the sensor and the driving member, wherein
the at least one processor is configured to generate a first moving signal according to the position information and transmit the first moving signal to the driving member, and the driving member is configured to control the projection lens module to move relative to the projection device according to the first moving signal.

2. The projection device according to claim 1, further comprising:
a storage medium, coupled to the at least one processor and configured to store a lookup table, wherein
the at least one processor is configured to obtain a moving range of the projection lens module according to the position information and the lookup table, and the at least one processor is configured to generate the first moving signal according to a minimum value of the moving range.

3. The projection device according to claim 2, wherein the minimum value of the moving range corresponds to a minimum projection size of an image projected by the projection device, and a maximum value of the moving range corresponds to a maximum projection size of the image projected by the projection device.

4. The projection device according to claim 2, further comprising:
an input device, coupled to the at least one processor, wherein
the at least one processor is configured to receive an user command through the input device and generate a second moving signal according to the user command and the moving range, wherein
the at least one processor is configured to transmit the second moving signal to the driving member, and the driving member is configured to control the projection lens module to move relative to the projection device according to the second moving signal.

5. The projection device according to claim 4, wherein
the at least one processor is configured to project an on-screen display menu having a range of the projection size corresponding to the moving range through the projection lens module, and the at least one processor is configured to receive the user command in response to projecting the on-screen display menu.

6. The projection device according to claim 4, wherein
the at least one processor is configured to record a mapping relationship between the position information and the second moving signal in the storage medium.

7. The projection device according to claim 2, wherein the at least one processor is configured to:
determine whether the storage medium stores a mapping relationship between the position information and a second moving signal; and
in response to determining that the storage medium does not store the mapping relationship, obtain the moving range of the projection lens module according to the position information and the lookup table.

8. The projection device according to claim 1, further comprising:
a storage medium, coupled to the at least one processor, wherein the at least one processor is configured to:
determine whether the storage medium stores a mapping relationship between the position information and the first moving signal; and
in response to determining the storage medium stores the mapping relationship, generate the first moving signal according to the mapping relationship.

9. The projection device according to claim 1, wherein the sensor comprises a time of flight sensor, and the position information comprises a distance between the projection device and a projection target.

10. The projection device according to claim 1,
wherein the at least one processor is configured to periodically detect whether the position information changes,
in response to the change of the position information, the at least one processor generates a second moving signal according to the changed position information and transmits the second moving signal to the driving member, and the driving member controls the projection lens module to move relative to the projection device according to the second moving signal.

11. The projection device according to claim 1, further comprising:
a housing, wherein the projection lens module is embedded in the housing, and when the projection lens module moves, the projection lens module protrudes from the housing.

12. A control method of a projection device, wherein the projection device comprises a sensor, a driving member, at least one processor, and a projection lens module configured to project an image beam, and the control method comprises:
obtaining position information of the projection device by the sensor;
generating a first moving signal by the at least one processor according to the position information; and
according to the first moving signal, controlling the projection lens module by the driving member to move relative to the projection device.

13. The control method according to claim 12, wherein the step of generating the first moving signal by the at least one processor according to the position information comprises:
obtaining a moving range of the projection lens module according to the position information and a lookup table; and
generating the first moving signal according to a minimum value of the moving range.

14. The control method according to claim 13, further comprising:
receiving a user command, and generating a second moving signal according to the user command and the moving range; and
according to the second moving signal, controlling the projection lens module by the driving member to move relative to the projection device.

15. The control method according to claim 14, wherein the step of receiving the user command comprises:
projecting an on-screen display menu having a range of the projection size corresponding to the moving range by the projection lens module; and
in response to projecting the on-screen display menu, receiving the user command by the at least one processor.

16. The control method according to claim 14, further comprising:
recording a mapping relationship between the position information and the second moving signal by the at least one processor.

17. The control method according to claim 13, wherein the step of obtaining the moving range according to the position information and the lookup table comprises:
determining whether the projection device stores a mapping relationship between the position information and a second moving signal; and
in response to determining the projection device does not store the mapping relationship, obtaining the moving range according to the position information and the lookup table.

18. The control method according to claim 12, wherein the step of generating the first moving signal by the at least one processor according to the position information comprises:
determining whether the projection device stores a mapping relationship between the position information and the first moving signal; and
in response to determining the projection device stores the mapping relationship, generating the first moving signal according to the mapping relationship.

19. The control method according to claim 12, further comprising:
periodically detecting whether the position information changes by the at least one processor;
in response to the change of the position information, generating a second moving signal according to the changed position information; and
controlling the projection lens module to move relative to the projection device by the driving member according to the second moving signal.

20. The control method according to claim 12, wherein the projection device further comprises a housing, the projection lens module is embedded in the housing, and when the projection lens module moves, the projection lens module protrudes from the housing.
